(19) United States
(12) Patent Application Publication
(10) Pub. No.: US 2025/0102742 A1
(43) Pub. Date: Mar. 27, 2025

(54) APPARATUSES AND METHODS FOR DIRECTING LIGHT TO MULTIPLE INCOUPLER WAVEGUIDES

(71) Applicant: GOOGLE LLC, Mountain View, CA (US)

(72) Inventors: Daniel Adema, Kitchener (CA); Shreyas Potnis, Kitchener (CA); Timothy Paul Bodiya, Toronto (CA); Ian Andrews, Kitchener (CA)

(21) Appl. No.: 18/728,210

(22) PCT Filed: Jul. 21, 2022
(86) PCT No.: PCT/US2022/037850

§ 371 Date: Jul. 11, 2024

Related U.S. Application Data
(60) Provisional application No. 63/140,569, filed on Jan. 22, 2021.
(60) Provisional application No. 63/298,318, filed on Jan. 11, 2022.

(51) Int. Cl. G02B 6/42; G02B 27/01

(52) U.S. Cl. CPC G02B 6/4214; G02B 6/4206; G02B 6/4213; G02B 6/4215; G02B 27/0172; G02B 2027/0178

(57) ABSTRACT

The present disclosure describes techniques and arrangements for directing light from an optical engine to one of a plurality of incouplers in a multiple incoupler waveguide system. For example, the present disclosure describes a plurality of reflective and transmissive elements to selectively direct light based on a plurality of optical characteristics to a first incoupler or a second incoupler.

### BACKGROUND

In a conventional wearable heads-up display (WHUD), light beams from an image source are coupled into a light guide substrate, generally referred to as a waveguide, by an input optical coupling such as an in-coupling diffraction grating (i.e., an “incoupler”), which can be formed on a surface of the substrate or buried within the substrate. Once the light beams have been coupled into the waveguide, the light beams are “guided” through the substrate, typically by multiple instances of total internal reflection (TIR) to then be directed out of the waveguide by an output optical coupling (i.e., an “outcoupler”), which can also take the form of a diffractive optic. The light beams ejected from the waveguide overlap at an eye relief distance from the waveguide forming an exit pupil within which a virtual image generated by the image source can be viewed.

### SUMMARY

The present disclosure describes techniques and apparatuses to selectively direct light to multiple incouplers based on the light's optical characteristics utilizing a plurality of transmissive and reflective elements.

In one example embodiment, an apparatus includes a waveguide including a first incoupler and a second incoupler; and a plurality of reflective and transmissive elements to selectively direct light based on a plurality of optical characteristics to the first incoupler or the second incoupler

In certain embodiments of the apparatus, the plurality of reflective and transmissive elements separates light into a portion of light with a first optical characteristic of the plurality of optical characteristics and a portion of light with a second optical characteristic of the plurality of optical characteristics. The plurality of reflective and transmissive elements, in some embodiments, selectively directs the portion of light with the first optical characteristic to the first incoupler and the portion of light with the second optical characteristic to the second incoupler.

In certain embodiments of the apparatus, the plurality of optical characteristics is a plurality of wavelength ranges, wherein each of the incouplers is tuned to incouple light of one of the plurality of wavelength ranges. In some embodiments, the plurality of reflective and transmissive elements includes a mirror. In some embodiments, the plurality of reflective and transmissive elements includes a beam splitter, wherein the beam splitter is a dichroic beam splitter to separate light into two or more of the plurality of wavelength ranges. In certain embodiments, the plurality of reflective and transmissive elements includes an optical relay element to focus a first pupil plane associated with a first wavelength range of the plurality of wavelength ranges on the first incoupler or to focus a second pupil plane associated with a second wavelength range of the plurality of wavelength ranges on the second incoupler. For example, the optical relay element includes one or more of a lens group, reflector, metasurface, prism assembly with a total internal reflection (TIR) gap with the plurality of reflective and transmissive elements, or any combination thereof.

In certain embodiments of the apparatus, the plurality of optical characteristics is a plurality of polarization states, wherein each of the incouplers is tuned to incouple light of one of the plurality of polarization states. In some embodiments, the plurality of reflective and transmissive elements includes a polarization beam splitter and one or more waveplates.

In certain embodiments of the apparatus, the plurality of reflective and transmissive elements includes a plurality of lenses with different focal lengths. In some embodiments, the plurality of reflective and transmissive elements includes optical clean-up filters including color-selective filters or polarization-selective filters to remove light with undesired optical characteristics from being directed to the first incoupler or the second incoupler. In some embodiments, the plurality of reflective and transmissive elements receives light from a single optical engine and selectively directs the received light to the first incoupler or the second incoupler.

In another example embodiment, an apparatus includes a waveguide stack including a first waveguide substrate comprising a first incoupler, and a second waveguide substrate including a second incoupler that is offset with the first incoupler. The apparatus also includes a plurality of reflective and transmissive elements to selectively direct light based on a plurality of optical characteristics to the first incoupler or the second incoupler.

In certain embodiments of the apparatus, the plurality of reflective and transmissive elements directs light of a first optical characteristic of the plurality of optical characteristics to the first incoupler and light of a second optical characteristic of the plurality of optical characteristics to the second incoupler.

In certain embodiments, the apparatus further includes one or more additional waveguide substrates stacked over the second waveguide substrate, each of the one or more additional waveguide substrates including a respective additional incoupler that is laterally offset to the first incoupler, the second incoupler, and other respective additional incouplers. Furthermore, the plurality of reflective and transmissive elements is configured to selectively direct light based on the plurality of optical characteristics to the respective one or more additional incouplers.

In some embodiments of the apparatus, the plurality of reflective and transmissive elements includes a beam splitter. For example, in certain embodiments, the beam splitter is a dichroic beam splitter, and the plurality of optical characteristics is a plurality of distinct wavelength ranges. In this example, the dichroic beam splitter separates light into the plurality of distinct wavelength ranges for transmission to one of the incouplers. As another example, in other embodiments, the beam splitter is a polarization beam splitter, and the plurality of optical characteristics is a plurality of distinct polarization states. In this example, the polarization beam splitter separates light into the plurality of distinct polarization states for transmission to one of the incouplers.

In some embodiments of the apparatus, the plurality of reflective and transmissive elements includes one or more optical focusing elements to focus light toward one or more of the incouplers.

Another example embodiment includes a plurality of reflective and transmissive elements to receive input light from a single optical engine, separate the input light into at least two portions of light based on one or more optical characteristics; and selectively direct each of the at least two portions of light to one of a plurality of incouplers of a waveguide. In some embodiments, the plurality of reflective and transmissive elements includes elements and features as described within the present disclosure.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example display system having a support structure that houses a projection system configured to project images toward the eye of a user, in accordance with some embodiments.

FIG. 2 shows an example of a block diagram of a projection system that projects light representing images onto the eye of a user via a display system, such as the display system of FIG. 1, in accordance with some embodiments.

FIG. 3 shows an example of light propagation within a waveguide of a projection system, such as the projection system of FIG. 2, in accordance with some embodiments.

FIG. 4 shows an example of an expanded view of a waveguide stack, in accordance with some embodiments.

FIG. 5 shows an example of a top view and a side view of a portion of a waveguide stack and a portion of an optical scanner, in accordance with some embodiments.

FIG. 6 shows an example of a top view of a portion of a waveguide stack and a portion of an optical scanner, in accordance with some embodiments.

FIG. 7 shows another example of a top view of a portion of a waveguide stack and a portion of an optical scanner, in accordance with some embodiments.

FIG. 8 shows an example of a top view of a portion of a waveguide stack with three waveguides and a portion of an optical scanner, in accordance with some embodiments.

FIG. 9 shows an example of a top view of a portion of a waveguide stack and a portion of an optical scanner with a MEMS mirror, in accordance with some embodiments.

FIG. 10 shows a zoomed in view of FIG. 9, in accordance with some embodiments.

FIG. 11 shows an example of a top view of a portion of a waveguide stack and a portion of an optical scanner with optical focusing elements, in accordance with some embodiments.

FIG. 12 shows an example of a portion of a waveguide with multiple incouplers on a common waveguide and a portion of an optical scanner, in accordance with some embodiments.

FIG. 13 shows examples of pupil planes and multiple incouplers on a waveguide, in accordance with some embodiments.

FIG. 14 shows an example of pupil walk on an incoupler, in accordance with some embodiments.

FIG. 15 shows an example of a lens as a secondary optical relay element in an optical scanner, in accordance with some embodiments.

FIG. 16 shows an example of a metasurface as a secondary optical relay element in an optical scanner, in accordance with some embodiments.

FIG. 17 shows an example of an optical scanner with a plurality of reflective elements including a mirror, a beam splitter, an air gap, and multiple prisms, in accordance with some embodiments.

FIG. 18 shows an example of an optical scanner with a plurality of reflective elements including a mirror and a beam splitter, in accordance with some embodiments.

FIG. 19 shows examples of separating red light from blue+green light, in accordance with some embodiments.

FIG. 20 shows an example of multiple incouplers on a waveguide and an optical scanner utilizing polarization, in accordance with some embodiments.

FIG. 21 shows another example of multiple incouplers on a waveguide and an optical scanner utilizing polarization, in accordance with some embodiments.

FIG. 22 shows an example of multiple incouplers on a waveguide and an optical scanner including optical focusing elements, in accordance with some embodiments.

FIG. 23 shows an example of filtering light in a color-selective manner, in accordance with some embodiments.

FIG. 24 shows an example of filtering light in a polarization-selective manner, in accordance with some embodiments.

FIG. 25 shows an example of a waveguide with multiple incouplers, an optical scanner, and a display source as the optical engine, in accordance with some embodiments.

### DETAILED DESCRIPTION

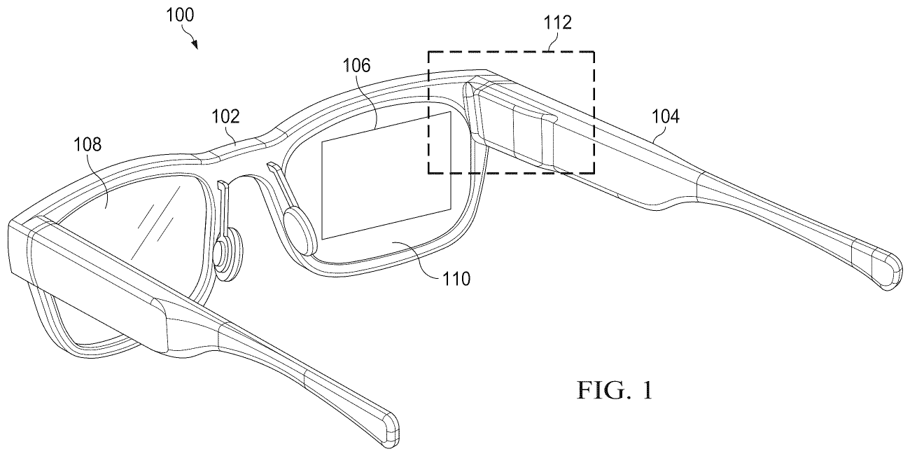

Waveguides with multiple incouplers in WHUDs offer the advantage of higher incoupling efficiencies since each incoupler can be tuned to incouple light of a particular optical characteristic such as a particular wavelength range. However, multiple incoupler waveguides typically require a separate projector and/or optical scanner for each incoupler, and there may not be enough room to accommodate such a configuration in the space-constrained form factors of WHUDs. FIGS. 1-25 illustrate techniques to selectively direct light from a single projector to multiple incouplers via an optical scanner with a plurality of transmissive and reflective elements based on the light's optical characteristics. Therefore, the advantages of a multiple incoupler waveguide are able to be realized in WHUDs with smaller form factors, thereby improving the overall user experience.

To illustrate, for a waveguide with multiple incouplers, a first incoupler is tuned to incouple light of a first optical characteristic (e.g., a first wavelength range), and a second incoupler is tuned to incouple light of a second optical characteristic (e.g., a second wavelength range). In some embodiments, the multiple incouplers are arranged via a waveguide stack where each waveguide in the waveguide stack has a corresponding incoupler. In other embodiments, the multiple incouplers are applied on a common waveguide. In either case, the optical scanner includes a plurality of reflective and transmissive elements such as mirrors, beam splitters, prisms, lenses, waveplates, or metasurfaces, or any combination thereof, that are designed and positioned to selectively direct light having one or more specified optical characteristics to a corresponding one of the multiple incouplers. Moreover, the optical scanner equalizes the optical path lengths (within a margin of difference) of the light directed to each incoupler. Accordingly, the pupil plane for each light path highly coincides with each incoupler, thereby increasing the amount of received light that is effectively incoupled and guided through the waveguide. This improves the quality of the image delivered by the waveguide while using a single projector.

To further illustrate via an example, in some embodiments a waveguide has two incouplers, designated the first incoupler and the second incoupler. The first incoupler is tuned to incouple red light, and the second incoupler is tuned to incouple blue and green light. Using the techniques described herein, the plurality of reflective and transmissive elements in the optical scanner receives light from a single optical engine (i.e., projector) and directs a red light portion of the received light to the first incoupler and directs a blue and green light portion of the received light to the second incoupler. In particular, the plurality of reflective and transmissive elements includes a dichroic mirror to reflect the red light portion to the first incoupler and to transmit the blue and green light portion. The plurality of reflective and transmissive elements further includes a mirror which receives this transmitted blue and green light portion from the dichroic mirror and reflects it to the second incoupler. Furthermore, the plurality of reflective and transmissive elements includes additional elements such as lenses and/or prisms to equalize (within a margin of difference) the optical path lengths of the red light portion directed to the first incoupler and of the blue and green light portion directed to the second incoupler so that the pupil plane of each light portion coincides with its respective incoupler. This increases the amount of incoupled light that is effectively propagated within the waveguide.

FIGS. 1-25 illustrate embodiments of a display system with an optical scanner for directing light to multiple incouplers, as described in greater detail below. However, it will be appreciated that the apparatuses and techniques of the present disclosure are not limited to implementation in this particular display system, but instead may be implemented in any of a variety of display systems using the guidelines provided herein.

FIG. 1 illustrates an example display system 100 having a support structure 102 that includes an arm 104, which houses a projection system configured to project images toward the eye of a user, such that the user perceives the projected images as being displayed in a field of view (FOV) area 106 of a display at one or both of lens elements 108, 110. In the depicted embodiment, the display system 100 is a wearable heads-up display (WHUD) that includes a support structure 102 configured to be worn on the head of a user and has a general shape and appearance of an eyeglasses (e.g., sunglasses) frame. The support structure 102 contains or otherwise includes various components to facilitate the projection of such images toward the eye of the user, such as a projector, an optical scanner, and a waveguide. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 further includes one or more batteries or other portable power sources for supplying power to the electrical components of the display system 100. In some embodiments, some or all of these components of the display system 100 are fully or partially contained within an inner volume of support structure 102, such as within the arm 104 in region 112 of the support structure 102. It should be noted that while an example form factor is depicted, it will be appreciated that in other embodiments the display system 100 may have a different shape and appearance from the eyeglasses frame depicted in FIG. 1.

One or both of the lens elements 108, 110 are used by the display system 100 to provide an augmented reality (AR) display in which rendered graphical content can be superimposed over or otherwise provided in conjunction with a real-world view as perceived by the user through the lens elements 108, 110. For example, light used to form a perceptible image or series of images may be projected by a projector of the display system 100 onto the eye of the user via a series of optical elements, such as a waveguide formed at least partially in the corresponding lens element, one or more scan mirrors, and one or more optical relays. One or both of the lens elements 108, 110 thus include at least a portion of a waveguide that routes display light received by an incoupler of the waveguide to an outcoupler of the waveguide, which outputs the display light toward an eye of a user of the display system 100. The display light is modulated and scanned onto the eye of the user such that the user perceives the display light as an image. In addition, each of the lens elements 108, 110 is sufficiently transparent to allow a user to see through the lens elements to provide a field of view of the user's real-world environment such that the image appears superimposed over at least a portion of the real-world environment.

In some embodiments, the projector is a digital light processing-based projector, a scanning laser projector, or any combination of a modulative light source such as a laser or one or more LEDs and a dynamic reflector mechanism such as one or more dynamic scanners or digital light processors. In some embodiments, the projector includes multiple laser diodes (e.g., a red laser diode, a green laser diode, and/or a blue laser diode) and at least one scan mirror (e.g., two one-dimensional scan mirrors, which may be micro-electromechanical system (MEMS)-based or piezo-based). The projector is communicatively coupled to the controller and a non-transitory processor-readable storage medium or memory storing processor-executable instructions and other data that, when executed by the controller, cause the controller to control the operation of the projector. In some embodiments, the controller controls a scan area size and scan area location for the projector and is communicatively coupled to a processor (not shown) that generates content to be displayed at the display system 100. The projector scans light over a variable area, designated the FOV area 106, of the display system 100. The scan area size corresponds to the size of the FOV area 106, and the scan area location corresponds to a region of one of the lens elements 108, 110 at which the FOV area 106 is visible to the user. Generally, it is desirable for a display to have a wide FOV to accommodate the outcoupling of light across a wide range of angles. Herein, the range of different user eye positions that will be able to see the display is referred to as the eyebox of the display.

In some embodiments, the projector routes light via first and second scan mirrors, an optical relay disposed between the first and second scan mirrors, and a waveguide disposed at the output of the second scan mirror. In some embodiments, an optical scanner, including one or more of the first scan mirror, the second scan mirror, or the optical relay, includes a plurality of reflective and transmissive elements to selectively direct light based on one of a plurality of different optical characteristics (e.g., wavelength range or polarization state) to a particular incoupler in a waveguide with multiple incouplers. The multiple incouplers offer the advantage of higher incoupling efficiency of light, thereby increasing the amount of light propagated through the waveguide to the corresponding outcouplers for outcoupling to the FOV area 106, where at least a portion of the outcoupler (or the outcouplers) overlaps the FOV area 106. Moreover, the optical scanner, as described in greater detail below, enables the multiple incoupler configuration within the form factors of support structure 102.

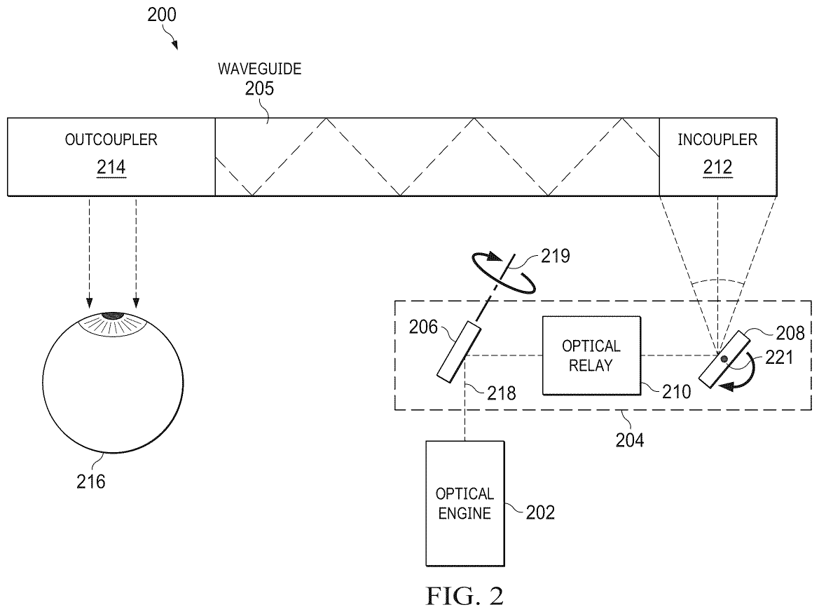

FIG. 2 illustrates a simplified block diagram of a projection system 200 that projects images directly onto the eye of a user via light, e.g., via laser light or via micro-display light. The projection system 200 includes an optical engine 202, an optical scanner 204, and a waveguide 205. In some embodiments, the optical scanner 204 includes a first scan mirror 206, a second scan mirror 208, and an optical relay 210. The waveguide 205 includes an incoupler 212 and an outcoupler 214, with the outcoupler 214 being optically aligned with an eye 216 of a user in the present example. In some embodiments, the projection system 200 is implemented in a wearable heads-up display or other display system, such as the display system 100 of FIG. 1.

In some embodiments, the optical engine 202 (also referred to as a projector) includes one or more light sources configured to generate and output light 218 (e.g., visible laser light such as red, blue, and green laser light and/or non-visible laser light such as infrared laser light). In some embodiments, the optical engine 202 is coupled to a driver or other controller (not shown), which controls the timing of emission of light from the light sources of the optical engine 202 in accordance with instructions received by the controller or driver from a computer processor coupled thereto to modulate the light 218 to be perceived as images when output to the retina of an eye 216 of a user. In some embodiments, the optical engine 202 includes one or more laser light sources. In other embodiments, the optical engine 202 includes one or more light emitting diode (LED) light sources or other type of LED display (e.g., a micro-LED display), a liquid crystal display (LCD), or a dot matrix display (DMD).

For example, during the operation of the projection system 200, multiple light beams having respectively different wavelengths are output by the light sources of the optical engine 202, then combined via a beam combiner (not shown), before being directed to the eye 216 of the user. The optical engine 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In some embodiments, one or both of the scan mirrors 206 and 208 of the optical scanner 204 are MEMS mirrors. For example, the scan mirror 206 and the scan mirror 208 are MEMS mirrors that are driven by respective actuation voltages to oscillate during active operation of the projection system 200, causing the scan mirrors 206 and 208 to scan the light 218. Oscillation of the scan mirror 206 causes light 218 output by the optical engine 202 to be scanned through the optical relay 210 and across a surface of the second scan mirror 208. The second scan mirror 208 scans the light 218 received from the scan mirror 206 toward an incoupler 212 of the waveguide 205. In some embodiments, the scan mirror 206 oscillates along a first scanning axis 219, such that the light 218 is scanned in only one dimension (i.e., in a line) across the surface of the second scan mirror 208. In some embodiments, the scan mirror 208 oscillates or otherwise rotates along a second scanning axis 221. In some embodiments, the first scanning axis 219 is perpendicular to the second scanning axis 221.

In some embodiments, the incoupler 212 has a substantially rectangular profile and is configured to receive the light 218 and direct the light 218 into the waveguide 205. The incoupler 212 is defined by a smaller dimension (i.e., width) and a larger orthogonal dimension (i.e., length). In an embodiment, the optical relay 210 is a line-scan optical relay that receives the light 218 scanned in a first dimension by the first scan mirror 206 (e.g., the first dimension corresponding to the small dimension of the incoupler 212), routes the light 218 to the second scan mirror 208, and introduces a convergence to the light 218 in the first dimension to an exit pupil beyond the second scan mirror 208. Herein, an “exit pupil” in an optical system refers to the location along the optical path where beams of light intersect. For example, the possible optical paths of the light 218, following reflection by the first scan mirror 206, are initially spread along the first scanning axis, but later these paths intersect at an exit pupil beyond the second scan mirror 208 due to convergence introduced by the optical relay 210. For example, the width (i.e., smallest dimension) of a given exit pupil approximately corresponds to the diameter of the light corresponding to that exit pupil. Accordingly, the exit pupil can be considered a “virtual aperture.” According to various embodiments, the optical relay 210 includes one or more collimation lenses that shape and focus the light 218 on the second scan mirror 208 or includes a molded reflective relay that includes two or more spherical, aspheric, parabolic, and/or freeform lenses that shape and direct the light 218 onto the second scan mirror 208. The second scan mirror 208 receives the light 218 and scans the light 218 in a second dimension, the second dimension corresponding to the long dimension of the incoupler 212 of the waveguide 205. In some embodiments, the second scan mirror 208 causes the exit pupil of the light 218 to be swept along a line along the second dimension. In some embodiments, the incoupler 212 is positioned at or near the swept line downstream from the second scan mirror 208 such that the second scan mirror 208 scans the light 218 as a line or row over the incoupler 212.

In some embodiments, the optical engine 202 includes an edge-emitting laser (EEL) that emits a laser light 218 having a substantially elliptical, non-circular cross-section, and the optical relay 210 magnifies or minimizes the laser light 218 along its semi-major or semi-minor axis to circularize the laser light 218 prior to convergence of the laser light 218 on the second scan mirror 208. In some such embodiments, a surface of a mirror plate of the scan mirror 206 is elliptical and non-circular (e.g., similar in shape and size to the cross-sectional area of the laser light 218). In other such embodiments, the surface of the mirror plate of the scan mirror 206 is circular.

The waveguide 205 of the projection system 200 includes the incoupler 212 and the outcoupler 214. The term “waveguide,” as used herein, will be understood to mean a combiner using one or more of total internal reflection (TIR), specialized filters, and/or reflective surfaces, to transfer light from an incoupler (such as the incoupler 212) to an outcoupler (such as the outcoupler 214). In some display applications, the light is a collimated image, and the waveguide transfers and replicates the collimated image to the eye. In general, the terms “incoupler” and “outcoupler” will be understood to refer to any type of optical grating structure, including, but not limited to, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is configured as a transmissive grating (e.g., a transmissive diffraction grating or a transmissive holographic grating) that causes the incoupler or outcoupler to transmit light and to apply designed optical function(s) to the light during the transmission. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection. In the present example, the light 218 received at the incoupler 212 is relayed to the outcoupler 214 via the waveguide 205 using TIR. The light 218 is then output to the eye 216 of a user via the outcoupler 214. As described above, in some embodiments the waveguide 205 is implemented as part of an eyeglass lens, such as the lens 108 or lens 110 (FIG. 1) of the display system having an eyeglass form factor and employing the projection system 200.

In some embodiments, although shown as a single incoupler 212 in FIG. 2, the waveguide 205 includes multiple incouplers 212. The multiple incouplers are arranged either on a common waveguide such as waveguide 205 or on a stack of waveguides (multiple waveguides 205 stacked one another) with an incoupler on each waveguide. In some embodiments, each of the multiple incouplers is tuned to incouple light of a particular optical characteristic to increase the overall incoupling efficiency of projection system 200. Parameters of the incoupler grating that can be tuned include, but are not limited to, grating height, grating spacing, grating angles, and grating density. In order to effectively implement a multiple incoupler waveguide with a single optical engine 202, the optical scanner 204 includes a plurality of reflective and transmissive elements to separate the light 218 based on one or more optical characteristics and direct each portion of light to a respective incoupler. Moreover, the plurality of reflective and transmissive elements in the optical scanner are designed and positioned to equalize (within a margin of difference) the optical path lengths of light directed to each incoupler. The optical path lengths are understood to be a product of the geometric length of the path of light as well as the refractive index and the geometry of the mediums through which the light propagates. The optical scanner, including the plurality of reflective and transmissive elements, is described in further detail below.

The terms “incoupler” and “incoupler grating” are used to correspond with one another in this specification and the associated figures unless specifically indicated otherwise. Accordingly, discussion of a “first incoupler grating,” “second incoupler grating,” “third incoupler grating,” or the like (e.g., “first grating, “second grating, “third grating”), corresponds to a “first incoupler,” “second incoupler,” and “third incoupler,” respectively, unless indicated otherwise.

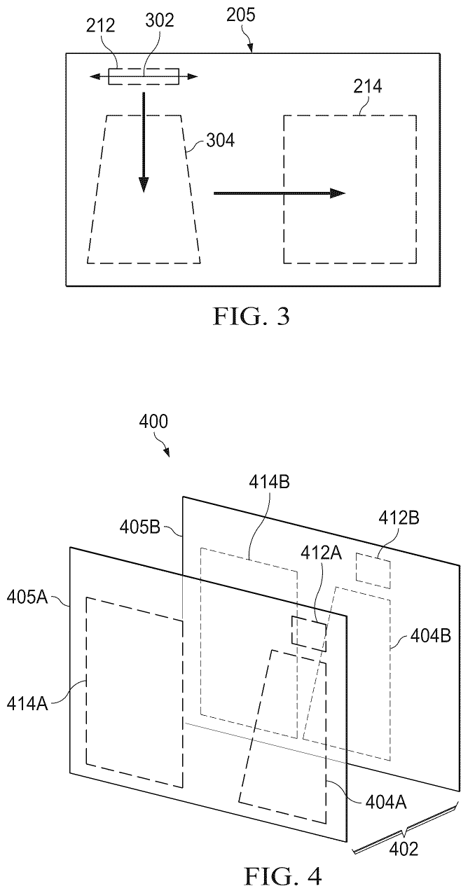

Although not shown in the example of FIG. 2, in some embodiments, the plurality of reflective and transmissive elements are included in any of the optical paths between the optical engine 202 and the scan mirror 206, between the scan mirror 206 and the optical relay 210, between the optical relay 210 and the scan mirror 208, between the scan mirror 208 and the incoupler 212, between the incoupler 212 and the outcoupler 214, and/or between the outcoupler 214 and the eye 216 (e.g., in order to shape the light for viewing by the eye 216 of the user). For example, in some embodiments, a prism or prism assembly is used to steer light from the scan mirror 208 into a corresponding incoupler 212 so that light is coupled into the corresponding incoupler 212 at the appropriate angle to encourage propagation of the light in waveguide 205 by TIR. Also, in some embodiments, an exit pupil expander (e.g., an exit pupil expander 304 of FIG. 3, described below), such as a fold grating, is arranged in an intermediate stage between incoupler 212 and outcoupler 214 to receive light that is coupled into waveguide 205 by the incoupler 212, expand the light, and redirect the light towards the outcoupler 214, where the outcoupler 214 then couples the light out of waveguide 205 (e.g., toward the eye 216 of the user). In some embodiments, the projection system 200 includes a plurality of exit pupil expanders, where each exit pupil expander optically couples a respective incoupler in a multiple incoupler system with a respective outcoupler.

FIG. 3 shows an example of light propagation within the waveguide 205 of the projection system 200 of FIG. 2 in accordance with some embodiments. Although shown with one incoupler 212, one exit pupil expander 304, and one outcoupler 214, it is appreciated that this is for clarity purposes, and the waveguide, in some embodiments, includes multiple instances of each. In such a configuration, for example, each incoupler 212 is tuned to incoupled light of a particular optical characteristic (e.g., wavelength range or polarization state) for forwarding to corresponding the exit pupil expander 304 and corresponding outcoupler 214. An optical scanner with a plurality of reflective and transmissive elements receives light, separates it, and directs each portion of light to one of the respective incouplers. As shown, light received via the incoupler 212, which is scanned along the axis 302, is directed into an exit pupil expander (EPE) 304 and is then routed to the outcoupler 214 to be output (e.g., toward the eye of the user). In some embodiments, the exit pupil expander 304 expands one or more dimensions of the eyebox of a WHUD that includes the projection system 200 (e.g., with respect to what the dimensions of the eyebox of the WHUD would be without the exit pupil expander 304). In some embodiments, the incoupler 212 and the exit pupil expander 304 each include respective one-dimensional diffraction gratings (i.e., diffraction gratings that extend along one dimension). In the example of FIG. 3, the incoupler 212 directs all, or a substantial portion of, the incoming light straight down (with respect to the presently illustrated view) in a first direction that is perpendicular to the scanning axis 302, and the exit pupil expander 304 directs light to the right (with respect to the presently illustrated view) in a second direction that is perpendicular to the first direction. While not shown in the present example, it should be understood that, in some embodiments, the first direction in which the incoupler 212 directs light is slightly or substantially diagonal, rather than exactly perpendicular, with respect to the scanning axis 302.

FIG. 4 shows an expanded view 400 of a waveguide stack 402 with multiple waveguides 405A, 405B. In some embodiments, the waveguide stack, including waveguides 405A, 405B, corresponds to the waveguide 205 of FIGS. 2 and 3. Each of the waveguides 405A, 405B in the waveguide stack has an incoupler 412A, 412B, respectively; an exit pupil expander (EPE) 404A, 404B, respectively; and an outcoupler 414A, 414B, respectively. The incouplers 412A, 412B of the waveguide stack 400 are arranged with an offset to one another, i.e., they do not completely overlap with respect to one another in the waveguide stack 400. This offset in incoupler position allows for light of a particular optical characteristic to be directed to the respective incoupler tuned to incouple light of that particular optical characteristic. For example, incoupler 412A is tuned to incoupled light of a first wavelength range (e.g., corresponding to red light) and incoupler 412B is tuned to incouple light of a second wavelength range (e.g., corresponding to blue and green light). By tuning the incouplers 412A, 412B to incouple light of a particular wavelength range and including the aforementioned offset, the overall incoupling efficiency of the waveguide stack is increased, thereby increasing the amount of light propagated through to the user.

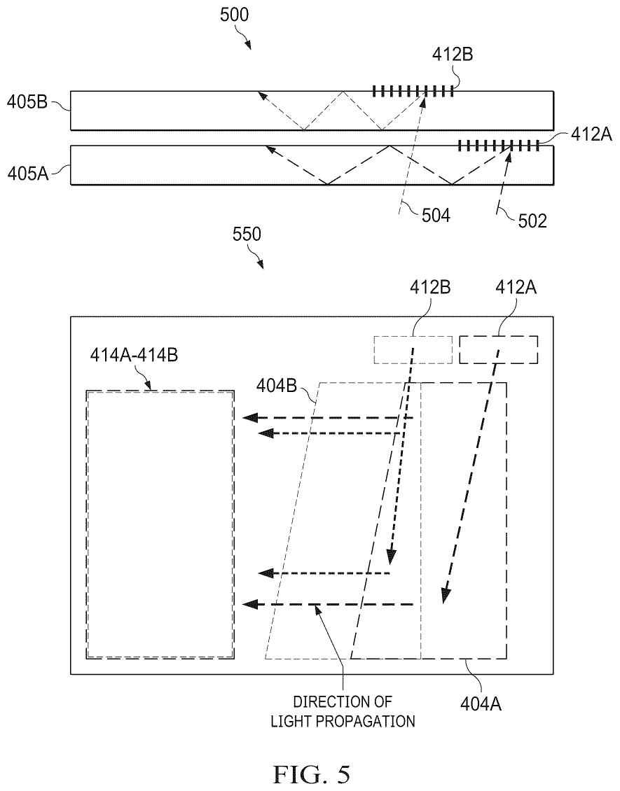

FIG. 5 shows a top view 500 and a side view 550 of a portion of waveguide stack, such as one corresponding to waveguide stack 402 including a first waveguide 405A and a second waveguide 405B. As shown, the incoupler 412A of the first waveguide 405A is offset from the incoupler 412B of the second waveguide 405B. Thus, light 502 that is incident on the incoupler 412A is incoupled and propagated within the first waveguide 405A and light 504 that is incident on the incoupler 412B is incoupled and propagated within the second waveguide 405B. The light propagated within the first waveguide 405A from the incoupler 412A is directed to and through a corresponding EPE 404A and on to the corresponding outcoupler 414A, and the light propagated within the second waveguide 405B from the incoupler 412B is directed to and through a corresponding EPE 404B and on to the corresponding outcoupler 414B. In this illustration, the outcouplers 414A, 414B are shown to be substantially overlapping to output light to a similar FOV of a WHUD, but it is appreciated that other configurations, e.g., an outcoupler dedicated to a specific portion of a total FOV of the WHUD, are similarly considered and covered by the present disclosure.

In some embodiments, each of the incouplers 412A, 412B is tuned to incouple light of a particular optical characteristic, such as a particular wavelength range or polarization state. For example, the light 502 directed to the first incoupler 412A has a wavelength range corresponding to red light, and the light 504 directed to the second incoupler 412b has a wavelength range corresponding to blue and green light. Techniques for an optical scanner to effectively separate light based on its wavelength ranges (i.e., colors) and direct each portion of light to a respective incoupler 412A, 412B are discussed in greater detail below. These techniques include use of a beam splitter to separate the light and reflective surface(s) to direct the portions of light to the corresponding incouplers. Furthermore, additional elements such as prisms and/or lenses, for example, equalize the optical path lengths of each portion of light to improve the quality of the image provided to the user.

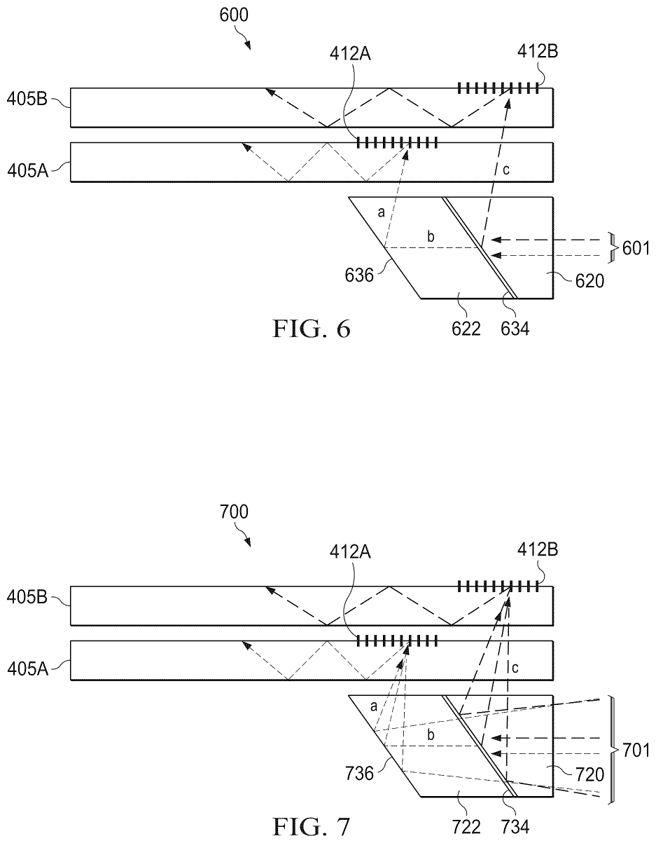

FIG. 6 shows a top view 600 of a portion of a waveguide stack with two waveguides 405A, 405B and a portion of an optical scanner with a plurality of reflective and transmissive elements 620, 622, 634, 636. In some embodiments, the waveguide stack with waveguides 405A, 405B corresponds with waveguide stack 402 in FIG. 2.

In some embodiments, the plurality of reflective and transmissive elements 620, 622, 634, 636 includes fold mirrors to receive input light 601 and separate it into portions of light based on one or more optical characteristics to deliver to incoupler 412A on waveguide 405A and to incoupler 412B on waveguide 404B. For example, incoupler 412B is tuned to incouple red light and incoupler 412A is tuned to incouple blue and green light. In this case, the plurality of reflective and transmissive elements includes a prism assembly with two prisms 620, 622, a first selectively transmissive layer 634 such as a dichroic mirror to transmit blue and green light toward incoupler 412A and reflect red light toward incoupler 412B, and a reflective surface 636 such as a mirror to reflect the blue and green light from the selectively transmissive layer 634 toward incoupler 412A. Furthermore, the plurality of reflective and transmissive elements 620, 622, 634, 636 are configured so that the pupil plane of each portion of separated light coincides with the respective incoupler locations (i.e., incouplers 412A, 412B) on the different planes (i.e., waveguides 405A, 405B). The optical path lengths satisfy (or fall within a specified margin of difference of) the relationship expressed as a+b=c, in other words, the length of the optical path for each portion of the separated light to reach the corresponding incoupler is the same. In this example, optical path portion “a” corresponds to the portion from reflective surface 636 to incoupler 412A, optical path portion “b” corresponds to the portion from the selectively reflective surface 634 to reflective surface 636, and optical path portion “c” corresponds to the portion from the selectively reflective surface 634 to incoupler 412B. In some embodiments, the prisms' 620, 622 dimensions and materials are selected to satisfy the aforementioned optical path length equation. For example, the materials are selected from one or more types of glass, one or more types of plastic, or any combination thereof. Furthermore, as illustrated in FIG. 6 and in the ensuing figures, the optical path lengths are in part based on the thickness of the waveguide substrates 405A, 405B. Accordingly, the optical scanner shown in FIG. 6 effectively guides each portion of light to the respective incoupler 412A, 412B while equalizing (within a margin of difference) the optical path lengths. This increases the amount of light incoupled into the waveguide 405A, 405B and the quality of the image delivered to the user.

FIG. 7 shows a top view 700 of a portion of waveguide stack with two waveguides 405A, 405B and a portion of an optical scanner with a plurality of reflective and transmissive elements 720, 722, 734, 736. In some embodiments, the waveguide stack with waveguides 405A, 405B corresponds with waveguide stack 402 in FIG. 2.

The plurality of reflective and transmissive elements includes a beam splitter 734 disposed between a prism assembly with two prisms 720, 722. In some embodiments, the beam splitter 734 is a polarization beam splitter, a dichroic beam splitter (i.e., dichroic mirror), or a proportional (i.e.: 50T/50R, 90T/10R, 33T/67R, 90R/10T, etc.) beam splitter. In general, the beam splitter 734 separates the input light into light of two or more optical characteristics. For example, a dichroic mirror is used to separate light into light of different wavelengths (i.e., colors) by reflecting red light to incoupler 412B and transmitting blue and green light that is then reflected off of reflective surface 736, such as a mirror, to incoupler 412A. In some embodiments, the dimensions and materials of the prisms 720, 722 are selected to satisfy (or be within a specified margin of difference of) the optical path length relationship expressed as a+b=c, i.e., the length of the optical path for each portion of the separated light to reach the corresponding incoupler is the same. In this example, optical path portions “a” correspond to the portions from reflective surface 736 to incoupler 412A, optical path portions “b” correspond to the portions from the beam splitter 734 to reflective surface 736, and optical path portions “c” correspond to the portions from the beam splitter 734 to incoupler 412B. For example, the materials are selected from one or more types of glass, one or more types of plastics, or any combination thereof. As shown in FIG. 7, even though the light 701 received by the first prism 720 includes a “n” light paths (in this example, n=three), the plurality of reflective and transmissive elements 720, 722, 734, 736 of the optical scanner are still able to separate and effectively guide the light of each optical characteristic to the respective incoupler while keeping the respective optical path lengths the same, i.e., aₙ+bₙ=cₙ. This increases the amount of light incoupled into the waveguide and the quality of the image delivered to the user.

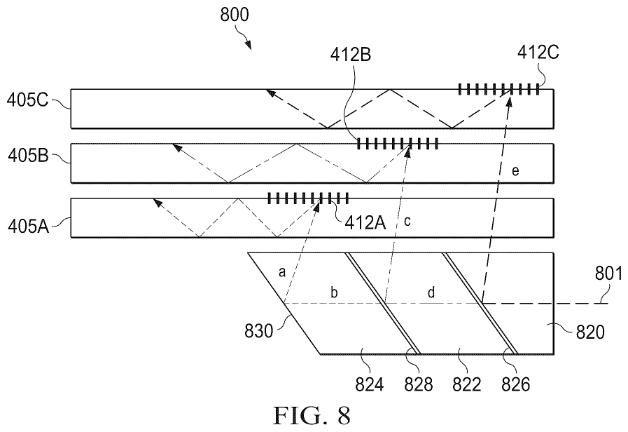

While two waveguides 405A, 405B are shown in the waveguide stack in FIGS. 4-7, in some embodiments, the waveguide stack includes three or more waveguides, where the incouplers of the waveguides are arranged at an offset with one another so that they do not completely overlap. Such a configuration is described in further detail in FIG. 8. Furthermore, it is appreciated that concepts discussed herein are scalable to other quantities, e.g., four or more waveguides in a waveguide stack, depending on the level of resolution of light needed based on optical considerations.

FIG. 8 shows a top view 800 of a portion of a waveguide stack with three waveguides 405A, 405B, and 405C along with their corresponding incouplers 412A, 412B, and 412C, respectively, and a portion of an optical scanner with a plurality of reflective and transmissive elements 820-830. In some embodiments, the plurality of reflective and transmissive elements includes a prism assembly with three prisms 820, 822, 824; two beam splitters 826, 828; and one reflective surface 830, such as a mirror. The beam splitters 826, 828 are one or more of a polarization beam splitter, a dichroic beam splitter (i.e., dichroic mirror), or a proportional (i.e.: 50T/50R, 90T/10R, 33T/67R, 90R/10T, etc.) beam splitter. In general, the beam splitters 826, 828 separate the light input 801 into the system into light of three optical characteristics. For example, in the case of separating light into different wavelength ranges, a first dichroic mirror 826 reflects light of a first wavelength range (e.g., red) to incoupler 412C and transmits light of a second (e.g., green) and a third (e.g., blue) wavelength range. A second dichroic mirror 828 reflects light of the second wavelength range (e.g., green) to incoupler 412B and transmits light of a third wavelength range (e.g., blue) that is then reflected off of reflective surface 830, such as a mirror, to incoupler 412A. In some embodiments, the dimensions and materials of the prisms 820, 822, 824 are selected to satisfy (or fall within a specified a margin of difference of) the optical path length relationship expressed as a+b+d=c+d=e, i.e., the length of the optical path for each portion of the separated light to reach the corresponding incoupler is the same. In this example, optical path portion “a” corresponds to the portion from reflective surface 830 to incoupler 412A, optical path portion “b” corresponds to the portion from the beam splitter 828 to reflective surface 830, optical path portion “c” corresponds to the portion from the beam splitter 828 to incoupler 412B, optical path portion “d” corresponds to the portion from beam splitter 826 to beam splitter 828, and optical path portion “e” corresponds to the beam splitter 826 to incoupler 412C. For example, the materials are selected from one or more types of glass, one or more types of plastics, or any combination thereof. This increases the amount of light incoupled into the waveguides 405A, 405B, 405C and the quality of the image delivered to the user.

The embodiment shown in FIG. 8 provides the added benefit of being able to tune more finely each of the incouplers to incouple light of a narrower range of optical characteristics. For example, each of the incouplers can be more finely tuned to incouple light of one of three wavelength ranges instead of just one of two wavelength ranges if two incouplers are used. This further increases the coupling efficiency of each incoupler as well as the overall coupling efficiency of the waveguide, resulting in a higher quality of image delivered to the user.

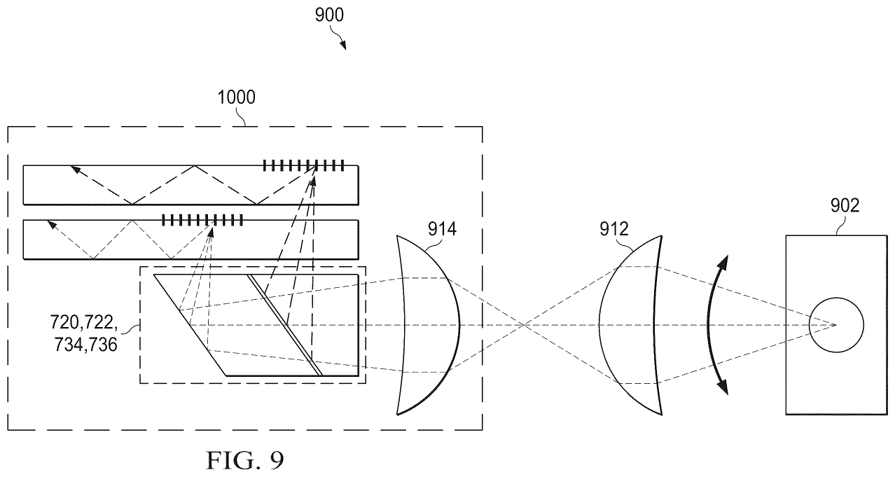

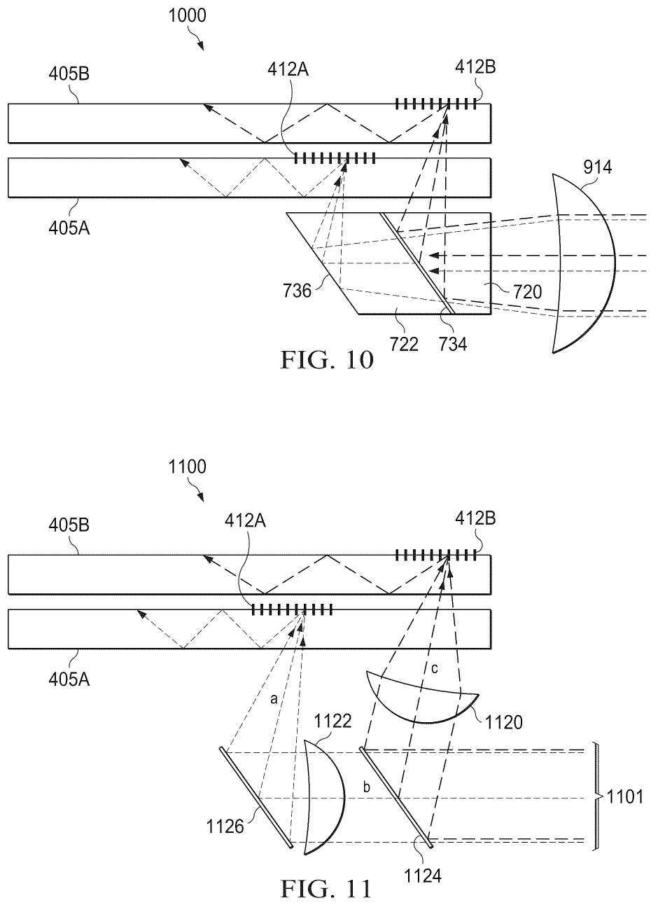

FIG. 9 shows a top view 900 of a block diagram of an optical scanner with an optical relay system, such as the one shown in FIG. 2, with optical focusing elements 912, 914 disposed in the light path from the scanning MEMS mirror 902 to a plurality of reflective and transmissive elements 720, 722, 734, 736, e.g., as shown in FIG. 7. In some embodiments, the MEMS mirror 902 corresponds to one of mirrors 206 or 208 in FIG. 2. In some embodiments, the MEMS mirror 902 corresponds with 206 and the plurality of reflective elements 720, 722, 734, 736 (in this example) are included in place of mirror 208 in FIG. 2. The optical focusing elements 912, 914 in the optical relay (such as one corresponding to 210) are lenses to direct light toward the plurality of reflective and transmissive elements 720, 722, 734, 736. FIG. 10 shows a zoomed in view 1000 on a portion of FIG. 9. As shown in FIG. 10, the optical focusing element 904 is placed before the plurality of transmissive and reflective elements 720, 722, 734, 736 to direct light into the first element, i.e., prism 720 in this example.

FIG. 11 shows a top view 1000 of a portion of a waveguide stack with two waveguides 405A, 405B and a portion of an optical scanner. In some embodiments, the waveguide stack with waveguides 405A, 405B corresponds with waveguide stack 402 in FIG. 2. The optical scanner includes a plurality of transmissive and reflective elements 1120, 1122, 1124, 1126 including optical focusing elements 1120, 1122 placed between a beam splitter 1124 and a reflective surface 1126 and the stacked waveguides 405A, 405B. In this embodiment, the two optical focusing elements 1120, 1122 are placed in the light paths after the beam splitter 1124, with optical focusing element 1120 between the beam splitter 1124 and incoupler 412B and optical focusing element 1122 between the beam splitter 1124 and reflective surface 1126. As shown in FIG. 11, the optical focusing elements 1120, 1122, along with beam splitter 1124 and reflective surface 1126, separate the received light 1101 into two portions and direct each portion so that it coincides with one of the two incouplers 412A, 412B, respectively. The dimensions and materials of the optical focusing elements 1120 and 1122 are designed and selected so that the light beams coincide with (within a margin of difference) the respective incouplers 412A, 412B. The plurality of transmissive and reflective elements 1120, 1122, 1124, 1126 are arranged and designed so as to satisfy (or fall within a specified margin of difference of) the optical path length relationship expressed as aₙ+bₙ=cₙ, i.e., the length of the optical path for each portion of the separated light to reach the corresponding incoupler is the same. In this example, optical path portions “aₙ” correspond to the portions from reflective surface 1126 to incoupler 412a, optical path portions “bₙ” correspond to the portions from beam splitter 1124 to reflective surface 1126, and optical path portions “cₙ” correspond to the portions from beam splitter 1124 to incoupler 412B, with n=3 in this example (corresponding to the three paths of light). For example, the materials are selected from one or more types of glass, one or more types of plastic, or any combination thereof. The configuration shown in FIG. 11 increases the coupling efficiency of each incoupler as well as the overall coupling efficiency of the waveguide, resulting in more light propagated in waveguides 405A, 405B and a higher quality of image delivered to the user.

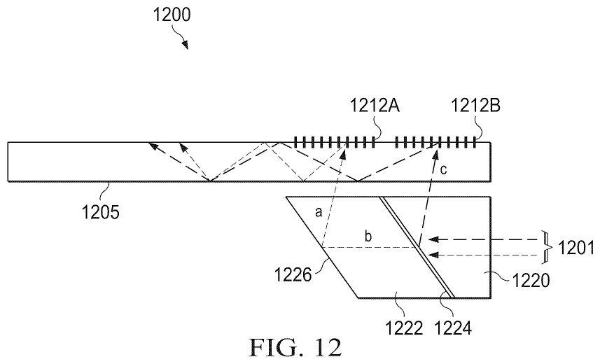

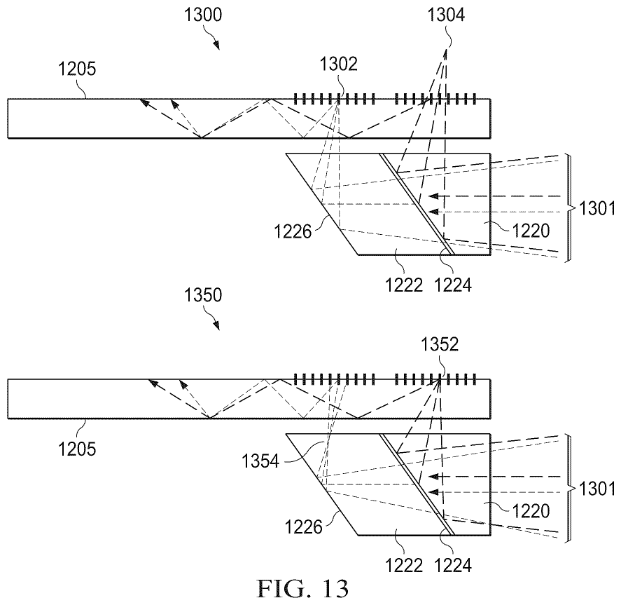

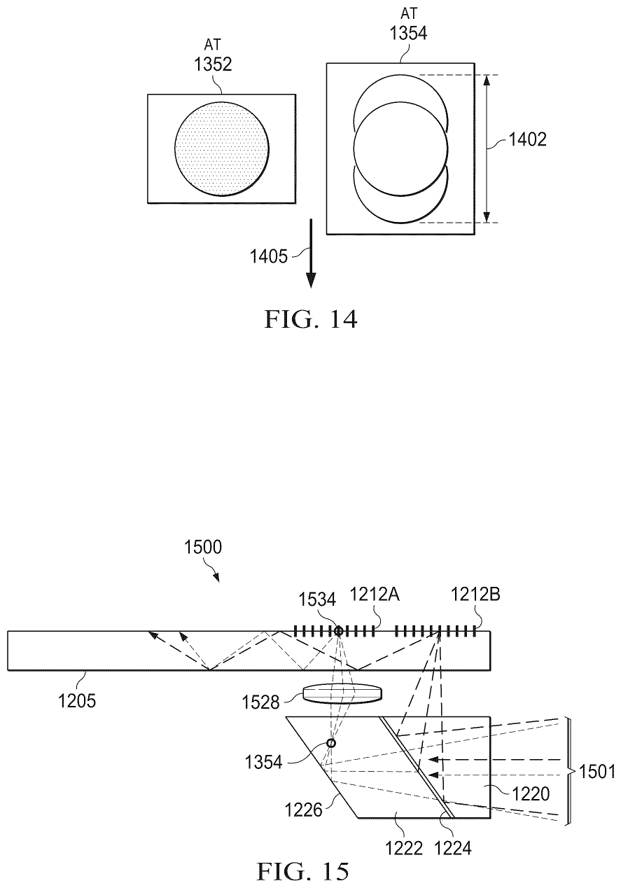

FIG. 12 shows a top view 1200 of a waveguide 1205, such as a portion of waveguide 205 of FIG. 2, with multiple incouplers 1212A, 1212B and a portion of an optical scanner. As shown in FIG. 12, the multiple incouplers 1212A and 1212B are arranged on a common waveguide substrate 1205. The optical scanner includes a plurality of reflective and transmissive elements 1220-1226, including a prism assembly with prisms 1220 and 1222; a beam splitter 1224; and a reflective surface 1226 to receive light 1201, separate it into two portions based on its optical characteristics, and direct each portion to a respective incoupler. However, unlike the waveguide stacks of the previous figures, the optical path lengths each portion of light directed to each incoupler are not equal, that is, the optical path relationship in this case is expressed as a+b≠c, where optical path portion “a” corresponds to the portion from reflective surface 1226 to incoupler 1212A, optical path portion “b” corresponds to the portion from the beam splitter 1224 to reflective surface 1226, and optical path portion “c” corresponds to the portion from the beam splitter 1224 to incoupler 1212B. Therefore, the pupil planes of the optical relay are not simultaneously coincident with both incoupler 1212A and 1212B. This is further illustrated by way of example in FIG. 13. As shown in 1300, the pupil plane of the first portion of light corresponding to the first incoupler is beyond the first incoupler (shown at 1304) when the pupil plane of the second portion of light coincides with a second incoupler (shown at 1302). Or, as shown in 1350, the pupil plane of the second portion of light corresponding to the second incoupler occurs before the second incoupler (shown at 1354) when the pupil plane of the first portion of light coincides with the first incoupler (shown at 1352). The scenario shown in 1350 results in pupil walk 1402 at the second incoupler 1354 and is shown in more detail in FIG. 14, where arrow 1405 shows the direction of light propagation. In some embodiments, to minimize double-bounce losses, the system will typically allow the color with the greater bounce spacing (i.e., red light) to have pupil walk 1402. As described in greater detail below, in some embodiments the plurality of reflective and transmissive elements includes a secondary optical relay element to refocus a secondary pupil plane on a respective incoupler, thus preventing or reducing pupil walk and improving the quality of the image provided by the waveguide.

For example, this secondary optical relay element is included in the optical path for the light incident on incoupler 1212A, as shown in FIGS. 15 and 16. In some embodiments, the secondary optical relay element is one of a lens group, a reflector, a metasurface, or a combination thereof. Although shown in the optical path to incoupler 1212A, in alternative embodiments, the secondary optical relay element is included in the optical path to incoupler 1212B, e.g., to address the scenario shown in 1300. The secondary optical relay element refocuses the light beams so that a secondary pupil plane is focused on the respective incoupler. This improves the quality of the image provided to the user. Additionally, since the multiple incouplers are located on a common waveguide substrate as opposed to a waveguide stack, the thickness of the waveguide component is reduced.

FIG. 15 shows a top view 1500 corresponding to 1350 with the addition of a lens 1528 as a secondary optical relay element to the plurality of reflective and transmissive elements. In some embodiments, the optical scanner also includes a plurality of reflective and transmissive elements 1220-1226, including a prism assembly with prisms 1220 and 1222, a beam splitter 1224, and a reflective surface 1226 that collectively receive light 1501, separate it into two portions based on its optical characteristics, and direct each portion to a respective incoupler 1212A, 1212B. As shown, the lens 1528 refocuses the portion of the second portion of the light beams that passes through beam splitter 1224 so that the secondary pupil plane 1534 coincides with incoupler 1212A. The original pupil plane 1354 is also shown. The dimensions and materials of the lens 1528 are designed and selected so that the secondary pupil plane 1534 coincides with incoupler 1212A. For example, the materials are selected from one or more types of glass, one or more types of plastic, or any combination thereof. Accordingly, pupil walk is minimized or avoided altogether.

FIG. 16 shows a top view 1600 of a similar configuration to that shown in FIG. 15 but with a metasurface 1628 as the secondary optical relay element instead of the lens 1528 shown in FIG. 15. The metasurface 1628 refocuses the light beams directed to incoupler 1212A so that the secondary pupil plane 1634 coincides with incoupler 1212A. The materials and/or the design of the metasurface are artificially engineered so that the secondary pupil plane 1634 coincides with incoupler 1212A. For example, the metasurface is composed of a thin-film including a series of elements that are specifically designed to provide the desired refractive qualities. Accordingly, pupil walk is minimized or avoided altogether, and the waveguide improves the quality of the image delivered to the user.

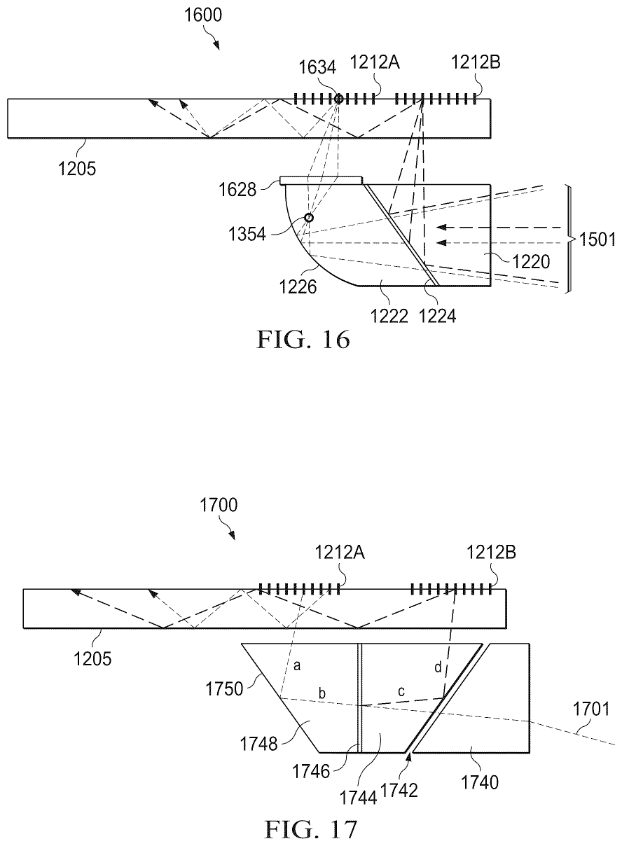

FIG. 17 shows a top view 1700 of a portion of a waveguide 1205, such one corresponding with waveguide 205 of FIG. 2, with multiple incouplers 1212A, 1212B and a portion of an optical scanner with a plurality of transmissive and reflective elements 1740, 1742, 1744, 1746, 1748, 1750 according to some embodiments. Similar to FIGS. 15-16, the waveguide 1205 includes multiple incouplers 1212A, 1212B. In this example, the additional prism 1740 and air gap 1742 in the plurality of reflective and transmissive elements 1740-1750 resolves the issue of pupil walk. The optical scanner also includes, in the plurality of reflective and transmissive elements, a prism assembly with prisms 1744 and 1748, beam splitter 1746, and a mirror 1750. The plurality of reflective and transmissive elements 1740-1750 equalize (within a margin of difference) the optical path lengths of the portions of light directed to the incouplers 1212A, 1212B. That is, the optical path lengths satisfy (or fall within a specified margin of difference of) the relationship expressed as a+b=c+d, i.e., the length of the optical path for each portion of the separated light to reach the corresponding incoupler is the same. In this example, optical path portion “a” corresponds to the portion from the mirror 1750 to incoupler 1212A, optical path portion “b” corresponds to the portion from the beam splitter 1746 to the mirror 1750, optical path portion “c” corresponds to the portion from the beam splitter 1746 to the interface at the prism 1744 and air gap 1742, and optical path portion “d” corresponds to the portion from the interface at the prism 1744 and air gap 1742 to incoupler 1212B. Specifically, the input light 1701 enters the prism 1740. The input angles and prism materials are designed and selected so that the TIR critical angle is not exceeded at the exit face/air gap 1742. The light continues until it interacts with the beam splitter 1746 disposed between prisms 1744 and 1748. A second portion of light continues through the beam splitter and reflects off the mirror surface 1750 toward the incoupler 1212A, while a first portion of light reflects off of the beam splitter 1746 back toward the air gap 1742, off of the interfacial surface of prism 1744 and airgap 1742, and toward incoupler 1212B. In some embodiments, the mirror surface 1750 is a TIR reflection surface, a metallic mirror, or a dielectric mirror.

The angles of the prisms shown in 1700 are designed such that the reflected light satisfies the TIR condition and is directed toward the respective incouplers, e.g., incoupler 1212B. Similar to the multiple substrate examples described earlier, the beam splitter 1746 is a polarization beam splitter, a dichroic beam splitter (i.e., dichroic mirror), or a proportional (i.e.: 50T/50R, 90T/10R, 33T/67R, 90R/10T, etc.) beam splitter. For example, a dichroic beam splitter is used to direct light of different wavelengths (i.e., color) to incouplers 1212A and 1212B. The dimensions and/or the materials of the plurality of reflective and transmissive elements 1740-1750 are selected such that optical path lengths a, b, c, and d satisfy the equation (or are within a margin of difference) a+b=c+d. Accordingly, pupil walk is minimized or avoided altogether, thus improving the quality of the image delivered to the user.

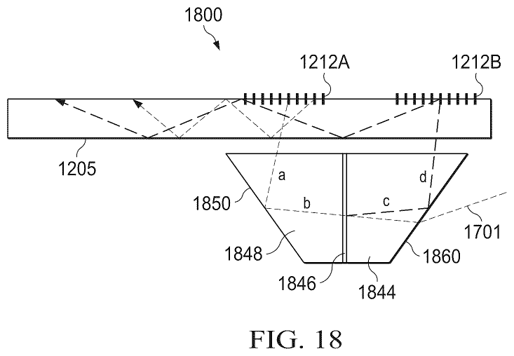

FIG. 18 shows a top view 1800 of a portion of a waveguide 1205, such one corresponding to waveguide 205 of FIG. 2, with multiple incouplers 1212A, 1212B and a portion of an optical scanner. The optical scanner includes a plurality of reflective and transmissive elements 1844-1850, including beam splitter 1846 and mirror 1850 as well as a prism assembly with prisms 1844, 1846. In some embodiments, the optical scanner shown in FIG. 18 is substantially similar to that shown in FIG. 17 with the exception that there is prism 1740 and air gap 1742 are absent. The dimensions and the materials of the plurality of reflective and transmissive elements 1844-1850 are selected so that optical path lengths a, b, c, and d satisfy (or fall within a specified margin of difference of) the relationship expressed as a+b=c+d, i.e., the length of the optical path for each portion of the separated light to reach the corresponding incoupler is the same. In this example, optical path portion “a” corresponds to the portion from the mirror 1850 to incoupler 1212A, optical path portion “b” corresponds to the portion from the beam splitter 1846 to the mirror 1850, optical path portion “c” corresponds to the portion from the beam splitter 1846 to the interface 1860 of prism 1844, and optical path portion “d” corresponds to the portion from the interface 1860 of prism 1844 to incoupler 1212B. Accordingly, pupil walk is minimized or avoided altogether, thus improving the quality of the image delivered to the user.

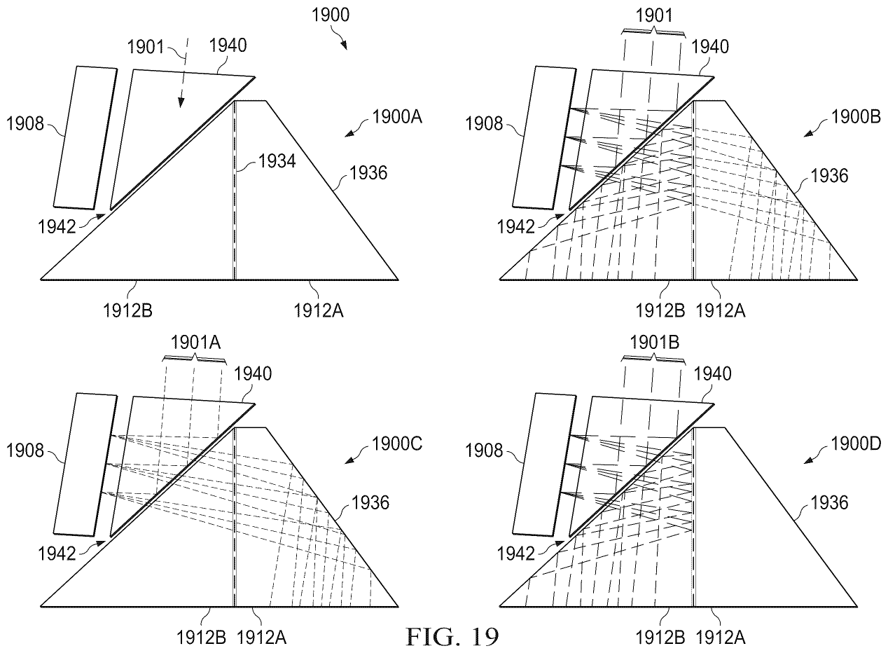

FIG. 19 shows diagrams 1900A-1900D illustrating examples of separating red light beams and blue+green light beams from incident light 1901. As shown in 1900A, the plurality of reflective and transmissive elements of an optical scanner includes the TIR prism 1940, air gap 1942, dichroic mirror 1934, a mirrored surface 1936, and a MEMS structure 1908. The area marked 1912B indicates the area the blue+green light beams take toward a respective incoupler, and the area marked 1912A indicates the area that the red light beams take toward a respective incoupler. 1900B shows the separation of the blue+green light beams from the red light beams, while 1900C focuses on the paths of the red light beams, and 1900D focuses on the paths of the blue+green light beams.

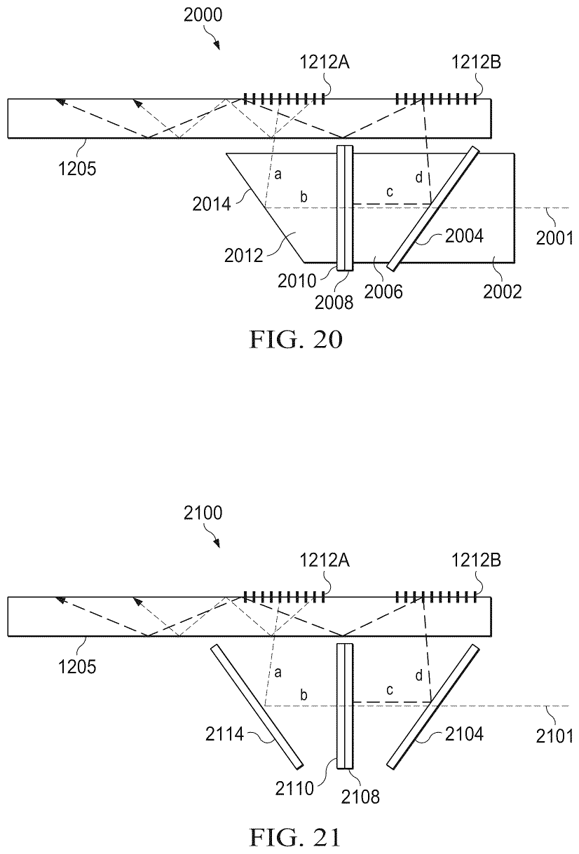

FIG. 20 shows a top view of a portion of a waveguide 1205, such as waveguide 205 of FIG. 2, with multiple incouplers 1212A and 1212B and a portion of an optical scanner. In this embodiment, the optical scanner includes a plurality of reflective and transmissive elements 2002-2014 that receive input light 2001, separate it into two portions based on polarization techniques, and direct each portion of light to one of the two incouplers 1212A, 1212B. For example, incoupler 1212A is tuned to incouple light of a first polarization state and incoupler 1212B is tuned to incouple light of a second polarization state. In some embodiments, polarization-separation techniques are selected over color-separation techniques depending on the system configuration to reduce the number of components or space. Depending on the coupler types, for example, polarization-separation techniques are selected as opposed to color-separation techniques due to the coupler response as a function of polarization vs color.

The plurality of reflective and transmissive elements 2002-2014 include a prism assembly with prisms 2002, 2006, 2012; a polarization beam splitter (PBS) 2004; a waveplate 2008; a beam splitter 2010; and a mirror 2014. In some embodiments, the waveplate 2008 is a fractional waveplate, e.g., a ¼-waveplate (QWP) or a ½ waveplate; the mirror 2414 is a TIR reflection, metallic mirror, or a dielectric mirror; and the beam splitter 2010 is a dichroic beam splitter or a proportional (i.e., 50T/50R, 90T/10R, 33T/67R, 90R/10T, etc.) beam splitter to separate light.

For example, P-polarized light 2001 enters the prism 2002 and transmits through the PBS 2004. The light passes through the waveplate 2008 and is converted to circular polarization. Some portion of light continues through the beam splitter 2010 and reflects off the mirror surface 2014 toward the incoupler 1212A, while the remaining light reflects off the beam splitter 2010 back through the waveplate 2008. The two passes through the waveplate 2008 convert the polarization state from P-polarization to S-polarization. The S-polarized light continues to and reflects off the PBS 2004 toward the incoupler 1212B. The materials and dimensions of the plurality of reflective and transmissive elements 2002-2014 are selected and designed so that optical path lengths a, b, c, and d satisfy (or fall within a specified margin of difference of) the relationship expressed as a+b=c+d, i.e., the length of the optical path for each portion of the separated light to reach the corresponding incoupler is the same. In this example, optical path portion “a” corresponds to the portion from the mirror 2014 to incoupler 1212A, optical path portion “b” corresponds to the portion from the beam splitter 2010 to the mirror 2014, optical path portion “c” corresponds to the portion from the beam splitter 2010 to PBS 2004, and optical path portion “d” corresponds to the portion from PBS 2004 to incoupler 1212B. Accordingly, the waveguide improves the quality of the image delivered to the user.

While FIG. 20 illustrates the plurality of reflective and transmissive elements such as the PBS 2004, waveplate 2008, beam splitter 2010, and mirror 2014 being implemented into a structure such as a prism assembly, in some embodiments, the same functioning is achieved using discrete components. In FIG. 21, the PBS 2104, waveplate 2108, beam splitter 2110, and the mirror 2114 correspond with the similar components in FIG. 20 with the exception being that they are implemented without the prism assembly shown in FIG. 20. In other words, the plurality of reflective and transmissive elements 2104, 2108, 2110, 2114 are discrete components that are designed and arranged so that optical path lengths a, b, c, and d satisfy (or fall within a specified margin of difference of) the relationship expressed as a+b=c+d, i.e., the length of the optical path for each portion of the separated light to reach the corresponding incoupler is the same. In this example, optical path portion “a” corresponds to the portion from the mirror 2114 to incoupler 1212A, optical path portion “b” corresponds to the portion from the beam splitter 2110 to the mirror 2114, optical path portion “c” corresponds to the portion from the beam splitter 2110 to PBS 2104, and optical path portion “d” corresponds to the portion from PBS 2104 to incoupler 1212B. Accordingly, the plurality of reflective and transmissive elements includes fewer components than shown in FIG. 20 while still being able to improve the quality of the image delivered by the waveguide.

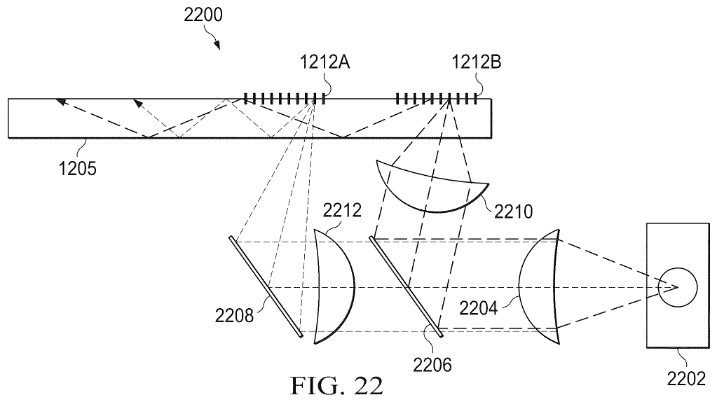

FIG. 22 shows a top view of a portion of a waveguide 1205, such one corresponding to waveguide 205 of FIG. 2, with multiple incouplers 1212A and 1212B and of a portion of an optical scanner. In this embodiment, the optical scanner includes a plurality of reflective and transmissive elements 2204-2212 that direct the light from a scanning MEMS mirror 2202 to one of the two incouplers 1212A, 1212B with the use of a plurality of optical lenses 2204, 2210, 2212 of different magnifications in the optical paths to each incoupler. For example, the focal length of lens 2210 is not equal to the focal length of lens 2212. Therefore, the magnification of each optical path of light to each incoupler 1212A, 1212B is different. This allows a fixed diameter spot size at the MEMS mirror 2202 (i.e., limited by the size of the mirror aperture) to be magnified by a different amount for different wavelength ranges/colors. For example, a system such as that shown in FIG. 22 is configured to output a 1.0 mm diameter blue spot and a 1.4 mm diameter red spot. In some embodiments, this feature is also achieved with a secondary optical relay element including additional lenses, reflectors, and/or metasurfaces.

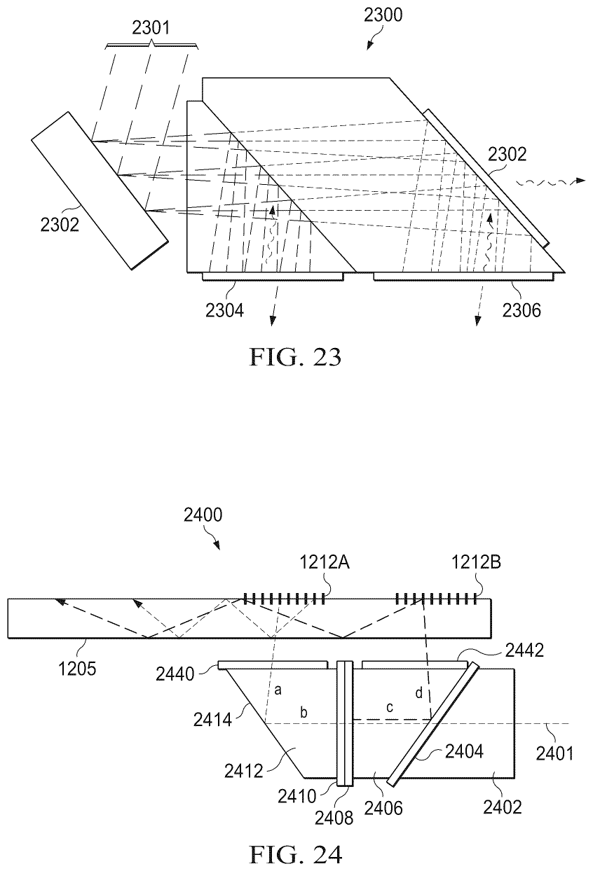

In any of the above-described configurations, a potential concern is that undesired light reaches the unintended incoupler, e.g., red light is directed toward the incoupler tuned to incoupler blue and green light. In some embodiments, clean-up filters in both optical paths prevent undesired light from reaching the unintended incoupler. The filters can be either color-selective (dichroic) as shown in FIG. 23 or polarization-selective as shown in FIG. 24.

FIG. 23 shows a top view 2300 of an optical scanner using optical clean-up filters 2302-2306 in separating incident light 2301. As shown, dielectric mirror 2302 reflects red light and transmits green light, dielectric mirror 2304 reflects red light and transmits green light, and dielectric mirror 2306 reflects green light and transmits red light. Accordingly, the green light is exclusively directed to an incoupler via dielectric mirror 2304 and red light is exclusively directed to another incoupler via dielectric mirror 2306. While this example shows the separation of green and red light, similar techniques can be used with respect to other colors, e.g., blue light. In some embodiments, blue light is also transmitted via dielectric mirror 2304 along with green light.

FIG. 24 shows a top view of a waveguide 1205, such as waveguide 205 of FIG. 2, with multiple incouplers 1212A and 1212B and an optical scanner. The optical scanner includes a plurality of reflective and transmissive elements 2402-2414 that direct the received light 2401 to one of the two incouplers 1212A, 1212B utilizing polarization techniques. The plurality of reflective and transmissive elements 2402-2414 include a prism assembly of prisms 2402, 2406, 2412; a PBS 2404; a waveplate 2408; a beam splitter 2410; and a mirror 2414. For example, the waveplate 2408 is a fractional waveplate, e.g., a QWP; the mirror 2414 is a TIR reflection, metallic mirror, or a dielectric mirror; and the beam splitter 2410 is a dichroic beam splitter or a proportional (i.e., 50T/50R, 90T/10R, 33T/67R, 90R/10T, etc.) beam splitter. In some embodiments, the plurality of reflective and transmissive elements 2402-2414 corresponds with the plurality of reflective and transmissive elements 2002-2014 in FIG. 20. Waveplate/filter 2440 and waveplate/filter 2442 are also included to alter the polarization states of incoming light for each respective incoupler 1212A, 1212B. The waveplates/filters 2440, 2442 include one or more QWPs, one or more ½ waveplates, or any combination thereof.

In some embodiments, parallel outputs at the incouplers are achieved with angular separation between colors in the optical relay by changing the angles of the plurality of reflective and transmissive elements, such as the beam splitters and/or mirrors. In other words, the different types of light input into the plurality of reflective and transmissive elements do not all have to be collinear. That is, the optical paths from the plurality of reflective elements to the incouplers are parallel but the incoming optical paths to the plurality of reflective and transmissive elements are not. Thus, in some embodiments, optical components are not required to make the individual color light beams collinear prior to the MEMS mirrors.

In some embodiments, the separation of light into light of different optical characteristics for directing to one of multiple incouplers (e.g., incouplers 1212A, 1212B on a common waveguide or incouplers 412A, 412B in a waveguide stack) is performed based on different wavelength ranges/colors of the light. For example, red and green light enter the waveguide at the first incoupler, while blue light enters the waveguide at the second incoupler. In another example, blue and green enter the waveguide at the first incoupler, while red enters at the second incoupler. In another example, red and blue light enter the waveguide at the first incoupler, while green light enters at the second incoupler.

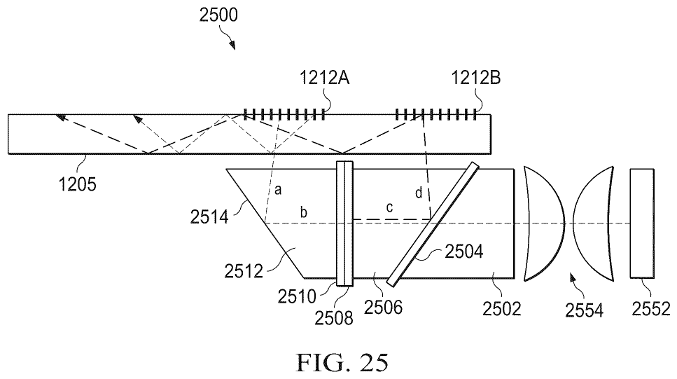

The techniques discussed above to make optical path lengths equivalent can also be extended to other display sources such as microLEDs, LCDs, and DMDs. This is illustrated in FIG. 25 with a display source 2552. An optical scanner including an optical relay 2554 with two lenses and a plurality of reflective and transmissive elements 2502-2514 directs the light from the display source 2552 to the two incouplers 1212A, 1212B. The plurality of reflective and transmissive elements 2502-2514 includes a prism assembly with three prisms 2502, 2506, 2512; a PBS 2504; a waveplate 2508; a beam splitter 2510; and a reflective surface 2514 such as a mirror. Accordingly, the plurality of reflective and transmissive elements directs the light to each of the incouplers to improve the quality of the image delivered by the waveguide.

Within the present disclosure, the discussed margin of difference of the optical path lengths is in the range of 15% or less, and in some embodiments, is 5% or less. In some embodiments, the margin of difference is understood to be a function of the thickness of the waveguide substrate (or of waveguide stack), and the optical scanners described herein minimize the margin of difference for the optical path lengths of light directed to each incoupler so that the margin of difference is less than the thickness of the waveguide.

Referring to FIGS. 1-25 the direction of incident light, grating features, and propagated light are depicted in the plane of the page for clarity. However, the direction of some or all of the light paths and/or features may be in or out of the plane of the page. Further, the techniques and systems described above are applicable to linescan MEMS relay system, as well as to 2-D optical relay systems.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. An apparatus comprising:
a waveguide comprising a first incoupler and a second incoupler; and
a plurality of reflective and transmissive elements to selectively direct light based on a plurality of optical characteristics to the first incoupler or the second incoupler.

2. The apparatus of claim 1, wherein the plurality of reflective and transmissive elements separates light into a portion of light with a first optical characteristic of the plurality of optical characteristics and a portion of light with a second optical characteristic of the plurality of optical characteristics, and selectively directs the portion of light with the first optical characteristic to the first incoupler and the portion of light with the second optical characteristic to the second incoupler.

3. The apparatus of claim 1, wherein the plurality of optical characteristics is a plurality of wavelength ranges, wherein each of the incouplers is tuned to incouple light of one of the plurality of wavelength ranges.

4. The apparatus of claim 3, wherein the plurality of reflective and transmissive elements comprises a mirror.

5. The apparatus of claim 3, wherein the plurality of reflective and transmissive elements comprises a beam splitter, wherein the beam splitter is a dichroic beam splitter to separate light into two or more of the plurality of wavelength ranges.

6. The apparatus of claim 5, wherein the plurality of reflective and transmissive elements comprises an optical relay element to focus a first pupil plane associated with a first wavelength range of the plurality of wavelength ranges on the first incoupler or to focus a second pupil plane associated with a second wavelength range of the plurality of wavelength ranges on the second incoupler.

7. The apparatus of claim 6, wherein the optical relay element comprises one or more of a lens group, reflector, metasurface, prism assembly with a total internal reflection (TIR) gap with the plurality of reflective and transmissive elements, or any combination thereof.

8. The apparatus of claim 1, wherein the plurality of reflective and transmissive elements comprises a plurality of lenses with different focal lengths.

9. The apparatus of claim 1, wherein the plurality of optical characteristics is a plurality of polarization states, and wherein each of the incouplers is tuned to incouple light of one of the plurality of polarization states.

10. The apparatus of claim 9, wherein the plurality of reflective and transmissive elements comprises a polarization beam splitter and one or more waveplates.

11. The apparatus of claim 1, wherein the plurality of reflective and transmissive elements comprises optical clean-up filters comprising color-selective filters or polarization-selective filters to remove light with undesired optical characteristics from being directed to the first incoupler or the second incoupler.

12. The apparatus of claim 1, wherein the plurality of reflective and transmissive elements receives light from a single optical engine and selectively directs the received light to the first incoupler or the second incoupler.

13. An apparatus comprising:
a waveguide stack comprising:
a first waveguide substrate comprising a first incoupler; and
a second waveguide substrate comprising a second incoupler that is offset with the first incoupler; and
a plurality of reflective and transmissive elements to selectively direct light based on a plurality of optical characteristics to the first incoupler or the second incoupler.

14. The apparatus of claim 13, wherein the plurality of reflective and transmissive elements directs light of a first optical characteristic of the plurality of optical characteristics to the first incoupler and light of a second optical characteristic of the plurality of optical characteristics to the second incoupler.

15. The apparatus of claim 13, the waveguide stack comprising:
one or more additional waveguide substrates stacked over the second waveguide substrate, each of the one or more additional waveguide substrates comprising a respective additional incoupler that is laterally offset to the first incoupler, the second incoupler, and other respective additional incouplers; and
the plurality of reflective and transmissive elements configured to selectively direct light based on the plurality of optical characteristics to the respective one or more additional incouplers.

16. The apparatus of claim 13, wherein the plurality of reflective and transmissive elements comprises a beam splitter.

17. The apparatus of claim 16, wherein the beam splitter is a dichroic beam splitter, wherein the plurality of optical characteristics is a plurality of distinct wavelength ranges, and wherein the dichroic beam splitter separates light into the plurality of distinct wavelength ranges for transmission to one of the incouplers.

18. The apparatus of claim 16, wherein the beam splitter is a polarization beam splitter, wherein the plurality of optical characteristics is a plurality of distinct polarization states, and wherein the polarization beam splitter separates light into the plurality of distinct polarization states for transmission to one of the incouplers.

19. The apparatus of claim 13, wherein the plurality of reflective and transmissive elements comprises:
one or more optical focusing elements to focus light toward one or more of the incouplers.

20. A plurality of reflective and transmissive elements to:
receive input light from a single optical engine;
separate the input light into at least two portions of light based on one or more optical characteristics; and
selectively direct each of the at least two portions of light to one of a plurality of incouplers of a waveguide.
